(19) United States
(12) Patent Application Publication
(10) Pub. No.: US 2012/0225273 A1
(43) Pub. Date: Sep. 6, 2012

(54) POLYETHYLENE RESIN FILM

(75) Inventors: Jumma Nomura, Sodegaura-shi (JP); Yoshinobu Nozue, Ichihara-shi (JP); Akiko Sekino, Chiba-shi (JP)

(73) Assignee: SUMITOMO CHEMICAL COMPANY, LIMITED, Chuo-ku, Tokyo (JP)

(21) Appl. No.: 13/505,499

(22) PCT Filed: Nov. 12, 2010
(86) PCT No.: PCT/JP2010/070639

§ 371 Date: May 2, 2012

(30) Foreign Application Priority Data
Nov. 17, 2009 (JP) 2009-261630
Jan. 18, 2010 (JP) 2010-007958

(51) Int. Cl. B32B 27/36; C08L 23/08

(52) U.S. Cl. 428/220; 525/190

(57) ABSTRACT

A polyethylene-based resin film is provided, wherein the film is formed of a resin composition comprising the following component (A), component (B) and component (C): component (A) is an aliphatic polyester; component (B) is an ethylene-a-olefin copolymer having an activation energy of flow (Ea) of from 45 to 100 kJ/mol; and component (C) is a compatibilizer for component (A) and component (B). When the total amount of component (A), component (B) and component (C) contained in the resin composition is 100% by weight, the content of component (A) is from 18 to 40% by weight, the content of component (B) is from 55 to 77% by weight, and the content of component (C) is from 3 to 15% by weight.

### TECHNICAL FIELD

The present invention relates to a polyethylene-based resin film.

### BACKGROUND ART

Conventionally, as a film used as a packaging material, films formed of a resin such as polyester represented by polyethylene terephthalate, polyolefin such as polyethylene and polypropylene, and nylon are known. However, the films formed of such resins have problems of generating high combustion heat by incineration and accelerating deterioration of an incinerator by this combustion heat.

On the other hand, since a polylactic acid and a poly-3-hydroxybutylic acid ester are plant-based resins and are biodegraded in natural environments, the film using these resins as a raw material is expected to facilitate waste disposal.

Therefore, it has been attempted to use conventional polyolefin or the like in combination with a polylactic acid. In Japanese Patent Publication No. 2005-232228, a resin composition formed of 1 to 99% by weight of a poly-3-hydroxybutyrate-based polymer and/or polylactic acid and 99 to 1% by weight of a polyethylene-based resin is disclosed.

However, when a polyethylene-based resin film using the resin composition as described in Japanese Patent Publication No. 2005-232228 is produced, it cannot be said that the obtained film has enough balance of impact strength, stiffness, light reducing properties and ease of cutting.

### DISCLOSURE OF THE INVENTION

In consideration of the above-described problems, an object of the present invention is to provide a polyethylene-based resin film having a good balance of impact strength, stiffness and light reducing properties and having ease of cutting.

The present invention provides a polyethylene-based resin film, wherein the film is formed of a resin composition comprising the following component (A), component (B) and component (C), and when the total amount of the component (A), the component (B) and the component (C) contained in the resin composition is 100% by weight, the content of the component (A) is from 18 to 40% by weight, the content of the component (B) is from 55 to 77% by weight, and the content of the component (C) is from 3 to 15% by weight:
component (A): an aliphatic polyester,
component (B): an ethylene-α-olefin copolymer having an activation energy of flow (Ea) of from 45 to 100 kJ/mol,
component (C): a compatibilizer for the component (A) and the component (B).

### MODE FOR CARRYING OUT THE INVENTION

The present invention is a polyethylene-based resin film formed of a resin composition containing the following component (A), component (B) and component (C):
Component (A): an aliphatic polyester,
Component (B): an ethylene-α-olefin copolymer having an activation energy of flow (Ea) of from 45 to 100 kJ/mol,
Component (C): a compatibilizer for the component (A) and the component (B).

Hereinbelow, it is described in detail. A “polyethylene-based resin film” may be simply herein referred to as a “film”.

### [Resin Composition]

### <Component (A): Aliphatic Polyester>

The aliphatic polyester in the present invention includes polyester obtained by polymerizing a hydroxycarboxylic acid and polyester obtained by copolymerizing a diol and a dicarboxylic acid. They may be used alone or in combination of two or more thereof.

The polyester obtained by polymerizing a hydroxycarboxylic acid includes a polymer comprising a repeating unit derived from 3-hydroxyalkanoate shown in the following general formula (1).

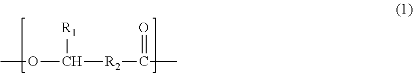

wherein R₁ is a hydrogen atom or an alkyl group having 1 to 15 carbon atoms, and R₂ is a single bond or an alkylene group having 1 to 4 carbon atoms.

The polymer comprising a repeating unit shown in the formula (1) may be a homopolymer and may be a multicomponent copolymer containing two or more kinds of the repeating units. The multicomponent copolymer may be any of a random copolymer, an alternating copolymer, a block copolymer, a graft copolymer, and the like.

The homopolymer includes a polylactic acid, polycaprolactone, a poly-3-hydroxybutyrate, poly(4-hydroxybutyrate), poly(3-hydroxypropionate), and the like. The multicomponent copolymer includes 3-hydroxybutyrate-3-hydroxypropionate copolymer, 3-hydroxybutyrate-4-hydroxybutyrate copolymer, 3-hydroxybutyrate-3-hydroxyvalerate copolymer, 3-hydroxybutyrate-3-hydroxyhexanoate copolymer, 3-hydroxybutyrate-3-hydroxyoctanoate copolymer, 3-hydroxybutyrate-3-hydroxyvalerate-3-hydroxyhexanoate-4-hydroxybutyrate copolymer, 3-hydroxybutyrate-lactic acid copolymer, and the like. Among them, a polylactic acid, a poly-3-hydroxybutyrate or a mixture thereof is preferably used.

The aliphatic polyester obtained by copolymerizing a diol and a dicarboxylic acid includes polyethylene succinate, polybutylene succinate, polyethylene adipate, polybutylene adipate, butylene succinate-butylene adipate copolymer, butylene succinate-butylene terephthalate copolymer, butylene adipate-butylene terephthalate copolymer, ethylene succinate-ethylene terephthalate copolymer, and the like.

As the aliphatic polyester, a polylactic acid is preferably used. Herein, the polylactic acid in the present invention includes a polymer consisting of a repeating unit derived from L-lactic acid and/or D-lactic acid, a copolymer comprising a repeating unit derived from L-lactic acid and/or D-lactic acid and a repeating unit derived from a monomer other than L-lactic acid and D-lactic acid, and a mixture of the polymer and the copolymer. Herein, the monomer other than L-lactic acid and D-lactic acid includes hydroxycarboxylic acids such as glycolic acid, aliphatic polyvalent alcohols such as butanediol and aliphatic polyvalent carboxylic acids such as succinic acid.

The content of the repeating unit derived from L-lactic acid or D-lactic acid in a polylactic acid is preferably 80% by mol or more, more preferably 90% by mol or more, and further preferably 95% by mol or more, from the viewpoint of enhancing the heat resistance of the obtained film. The melt flow rate (MFR) of polylactic acid is preferably 1 g/10 min or more, more preferably 2 g/10 min or more, further preferably 3 g/10 min or more, further more preferably 5 g/10 min or more, and most preferably 10 g/10 min or more, from the viewpoint of flowability. In addition, from the viewpoint of the strength of the film, the melt flow rate is 20 g/10 min or less, more preferably 18 g/10 min or less, and further preferably 15 g/10 min or less. Herein, the MFR is measured under conditions of a load of 21.18 N and a temperature of 190° C., according to A-method in the method prescribed in JIS K7210-1995.

### <Component (B): Ethylene-α-Olefin Copolymer>

The ethylene-α-olefin copolymer in the present invention is an ethylene-α-olefin copolymer with a content of a repeating unit derived from ethylene of 50% by weight or more.

The ethylene-α-olefin copolymer includes a copolymer of ethylene and one or more α-olefin having 3 to 12 carbon atoms. Examples of the α-olefin having 3 to 12 carbon atoms include propylene, 1-butene, 1-pentene, 4-methylpentene-1, 1-hexene, 1-octene, 1-decene, and the like. Among them, propylene, 1-butene, 1-hexene and 1-octene are preferably used, and 1-butene and 1-hexene are more preferably used.

Examples of the ethylene-α-olefin copolymer include an ethylene-propylene copolymer, an ethylene-1-butene copolymer, an ethylene-4-methylpenetene-1 copolymer, an ethylene-1-hexene copolymer, an ethylene-1-octene copolymer, an ethylene-propylene-1-butene copolymer, and the like. Among them, an ethylene-propylene copolymer, an ethylene-1-butene copolymer, an ethylene-1-hexene copolymer and an ethylene-1-octene copolymer are preferably used, and an ethylene-1-butene copolymer, an ethylene-1-hexene copolymer and an ethylene-1-butene-1-hexene copolymer are more preferably used.

The ethylene-α-olefin copolymer preferably has a density of from 905 to 950 kg/m³. From the viewpoint of stiffness of the film, the density is preferably 910 kg/m³ or more and more preferably 912 kg/m³ or more. In addition, from the viewpoint of impact strength of the film, the density is preferably 940 kg/m³ or less and more preferably 930 kg/m³ or less. The density of the component (A) is measured according to JIS K7112 (1999).

The ethylene-α-olefin copolymer preferably has a melt flow rate (MFR) of from 0.1 to 10 g/10 min. From the viewpoint of moldability of the film, the. MFR is more preferably 0.3 g/10 min or more and further preferably 0.5 g/10 min or more. From the viewpoint of mechanical strength of the obtained film, the MFR is preferably 8 g/10 min or less, more preferably 5 g/10 min or less, further preferably 3 g/10 min or less, and further more preferably 2 g/10 min or less. Herein, the melt flow rate is measured under conditions of a load of 21.18 N and a temperature of 190° C., according to the method prescribed in JIS K7210 (1995).

The ethylene-α-olefin copolymer preferably has an activation energy of flow (Ea) of from 45 to 100 kJ/mol. From the viewpoint of flowability, the Ea is preferably 50 kJ/mol or more, more preferably 55 kJ/mol or more, further preferably 60 kJ/mol or more, and further more preferably 65 kJ/mol or more. From the viewpoint of obtaining sufficient moldability at a high temperature, the Ea is preferably 100 kJ/mol or less and more preferably 90 kJ/mol or less.

The ethylene-α-olefin copolymer preferably has a η*_{0.1}/η*₁₀₀ of from 10 to 100. From the viewpoint of enhancing moldability, the η*_{0.1}/η*₁₀₀ is preferably 15 or more, more preferably 20 or more, and further preferably 25 or more. In addition, from the viewpoint of enhancing mechanical strength, it is preferably 90 or less, more preferably 80 or less, and further preferably 70 or less. Herein, the η*_{0.1} and η*₁₀₀ is measured at a measurement temperature of 190° C. using a viscoelasticity measuring instrument (for example, Rheometrics Mechanical Spectrometer RMS-800 manufactured by Rheometrics, Inc., and the like.). In the measurement of η*_{0.1}/η*₁₀₀, a pressed sheet with a thickness of 2.0 mm is formed using the ethylene-α-olefin copolymer at a temperature of 190° C., and a sample prepared by cutting out this pressed sheet into a disk shape with a diameter of 25 mm is used.

The ethylene-α-olefin copolymer preferably has a tensile impact strength of from 400 to 2000 kJ/m². From the viewpoint of enhancing mechanical strength, the tensile impact strength is preferably 450 kJ/m² or more, more preferably 500 kJ/m² or more, further preferably 550 kJ/m² or more, and further more preferably 600 kJ/m² or more. The tensile impact strength is measured according to ASTM D1822-68.

### <Component (C): Compatibilizer>

In the present invention, the component (C) is a compatibilizer of the component (A) and the component (B). The compatibilizer includes a polymer having an epoxy group and a styrene-based thermoplastic elastomer. As the component (C) that compatibilizer the component (A) and the component (B), the polymer having an epoxy group is preferably used.

Whether or not a compound falls under the component (C) is determined by the following method. Hereinafter, a compound is referred to as a component (X).

First, a mixture (1) obtained by mixing prescribed amounts of the component (A), the component (B) and the component (X) are melt-kneaded to obtain a resin composition (1). A film (1) is produced using the resin composition (1).

Next, a film (2) is produced using the component (B) in the same conditions as the conditions for producing the film (1).

The impact strength of the film (1) and the impact strength of the film (2) are measured. When the impact strength of the film (1) exceeds 50% of the impact strength of the film (2), the component (X) is a compatibilizer of the component (A) and the component (B), more specifically, the component (C).

The polymer having an epoxy group includes a copolymer comprising a repeating unit derived from ethylene and a repeating unit derived from a monomer having an epoxy group. Examples of the monomer having an epoxy group include α,β-unsaturated glycidyl esters such as glycidyl methacrylate and glycidyl acrylate, α,β-unsaturated glycidylethers such as allylglycidylether and 2-methylallylglycidylether, and preferable example is glycidyl methacrylate.

The polymer having an epoxy group specifically includes a glycidyl methacrylate-ethylene copolymer (for example, a trade name of Bondfast, manufactured by Sumitomo Chemical Co., Ltd.), and the polymer having an epoxy group includes a glycidyl methacrylate-styrene copolymer and a glycidyl methacrylate-acrylonitrile-styrene copolymer, a glycidyl methacrylate-propylene copolymer, and the like. In addition, those obtained by graft-polymerizing the monomer having an epoxy group in a solution or by melt kneading with polyethylene, polypropylene, polystyrene, an ethylene-α-olefin copolymer, hydrogenated or non-hydrogenated styrene-conjugated dienes or the like may be used.

In the polymer having an epoxy group, the content of the repeating unit derived from the monomer having an epoxy group is from 0.01% by weight to 30% by weight, preferably from 0.1% by weight to 20% by weight, more preferably from 5% by weight to 15% by weight, further preferably from 8% by weight to 15% by weight, and further more preferably from 10% by weight to 15% by weight (based on 100% by weight of the ethylene-based polymer having an epoxy group). The content of the repeating unit derived from the monomer having an epoxy group is measured by infrared study. Specifically, a pressed sheet is formed, the absorbance of a characteristic absorption of infrared absorption spectrum is corrected by the thickness, and the content of the repeating unit derived from the monomer having an epoxy group is obtained by a calibration curve method. A peak of 910 cm⁻¹ was used as the characteristic absorption of glycidyl methacrylate.

The polymer having an epoxy group has a melt flow rate (MFR) of from 1 g/10 min to 15 g/10 min. From the viewpoint of moldability, the MFR is preferably 1.5 g/10 min or more and more preferably 2 g/10 min or more. From the viewpoint of facilitating the reaction of the polymer having an epoxy group with other component, the MFR is preferably 8 g/10 min or less, more preferably 7 g/10 min or less, further preferably 5 g/10 min or less, and further more preferably 4 g/10 min or less. The melt flow rate used herein uses the value measured under conditions of a test load of 21.18 N and a temperature of 190° C., according to the method prescribed in JIS K 7210 (1995).

Examples of the method for producing the polymer having an epoxy group include a method of copolymerizing a monomer having an epoxy group with ethylene, and other monomer as necessary, a method of graft-polymerizing a monomer having an epoxy group with an ethylene-based resin, and the like, by a high pressure radical polymerization method, a solution polymerization method, an emulsion polymerization method or the like.

The polymer having an epoxy group may comprise a repeating unit derived from other monomer. Examples of the other repeating unit include unsaturated carboxylic esters such as methyl acrylate, ethyl acrylate, methyl methacrylate and butyl acrylate, unsaturated vinyl esters such as vinyl acetate and vinyl propionate, and the like.

A styrene-based thermoplastic elastomer can be used as the component (C) in the resin composition. Specific examples of the styrene-based thermoplastic elastomer include styrene-butadiene rubber (SBR) or a hydrogenated product thereof (H-SBR), a styrene-butadiene block copolymer (SBS) or a hydrogenated product thereof (SEBS), a styrene-isoprene block copolymer (SIS) or a hydrogenated product thereof (SEPS, HV-SIS), a styrene-(butadiene/isoprene) block copolymer, a styrene-(butadiene/isoprene) random copolymer, and the like.

As the content of each component in the resin composition used in the present invention, the content of the component (A) is from 18 to 40% by weight, the content of the component (B) is from 55 to 77% by weight, and the content of the component (C) is from 3 to 15% by weight, when the total amount of the components (A), (B) and (C) contained in the resin composition is defined as 100% by weight. Preferably, the content of the component (A) is from 20 to 35% by weight, the content of the component (B) is from 55 to 77% by weight, and the content of the component (C) is from 3 to 15% by weight. More preferably, the content of the component (A) is from 20 to 35% by weight, the content of the component (B) is from 55 to 77% by weight, and the content of the component (C) is from 3 to 10% by weight. Further preferably, the content of the component (A) is from 20 to 35% by weight, the content of the component (B) is from 55 to 75% by weight, and the content of the component (C) is from 3 to 10% by weight. Furthermore preferably, the content of the component (A) is from 25 to 35% by weight, the content of the component (B) is from 55 to 75% by weight, and the content of the component (C) is from 3 to 10% by weight. Most preferably, the content of the component (A) is from 25 to 35% by weight, the content of the component (B) is from 60 to 70% by weight, and the content of the component (C) is from 3 to 8% by weight. The compounding ratio of each component is set in the above-described ranges, whereby a film having a good balance of impact strength, stiffness and light reducing properties and having ease of cutting can be obtained.

Additives such as an antioxidant, a neutralizer, a lubricant, an antistatic agent, a nucleating agent, a UV inhibitor, a plasticizer, a dispersant, an anti-fog agent, an antimicrobial agent, an organic porous powder and a pigment can be added to the resin composition as necessary.

An olefin-based resin other than the component (B) may be added to the resin composition within a range that does not impair the effects of the present invention. Examples of the olefin-based resin other than the component (B) include an ethylene-α-olefin copolymer having an activation energy of flow of 44 kJ/mol or less, HDPE or high-pressure process low-density polyethylene.

The method for producing the resin composition is not particularly limited, and a known blending method can be used. Examples of the known blending method include a method of dry-blending or melt-blending the components (A) to (C) with other components such as an additive as necessary. Examples of the dry-blending method include methods using various blenders such as a Henschel mixer and a tumbler mixer, and examples of the melt-blending method include methods using various mixers such as a single screw extruder, a twin screw extruder, a Banbury mixer and a heat roller.

### [Method for Producing Film]

Examples of a method for producing the film according to the present invention include methods of producing by a blown film process, a flat die cast process and the like. The film obtained by such a process has a thickness of 500 μm or less, preferably from 5 to 300 μm, more preferably from 10 to 200 μm, and further preferably from 15 to 100 μm.

The blown film process is preferable as the method for producing the film. The temperature at which the film is produced is preferably from 180° C. to 230° C. From the viewpoint of moldability, the temperature is preferably 185° C. or more, more preferably 190° C. or more, preferably 220° C. or less, and further preferably 210° C. or less.

In a case where the film is produced by a flat die cast process, the temperature at which the film is produced is preferably from 150° C. to 280° C. From the viewpoint of suppressing thermal deterioration of the resin, the temperature is preferably 260° C. or less and more preferably 250° C. or less. Also, from the viewpoint of moldability, the temperature is preferably 180° C. or more, more preferably 200° C. or more, and further preferably 210° C. or more.

The film according to the present invention has a HAZE of preferably 20% or more, more preferably 25% or more, and further preferably 30% or more, from the viewpoint of light reducing properties. The light reducing properties herein mean properties to reduce the intensity of the incident light to the film and does not mean that the film completely blocks the incident light. The packaging bag formed of a film having light reducing properties reduces the intensity of the incident light, thus is suitable as a packaging bag for preserving a substance that is deteriorated by light. The film according to the present invention has a HAZE of preferably 90% or less, more preferably 80% or less, and further preferably 70% or less. Herein, the HAZE is measured by the method prescribed in ASTM D1003.

The stiffness of the film according to the present invention means 1% secant modulus. The film has a 1% secant modulus of preferably from 500 to 1200 MPa, more preferably 550 MPa or more, further preferably 575 MPa or more, further more preferably 600 MPa or more, and further more preferably 650 MPa or more.

The film has a 1% secant modulus of preferably 1100 MPa or less, more preferably 1000 MPa or less, further preferably 800 MPa or less, and further more preferably 750 MPa or less.

Herein, the 1% secant modulus is a value obtained by performing a tensile test using a rectangular test specimen of 20 mm in width and 120 mm in length under conditions of a chuck interval of 60 mm and a tensile rate of 5 mm/min, obtaining a load (unit: N) at 1% elongation of the test specimen from the stress-strain curve obtained by measuring stress and strain, and calculating by the following formula.

1% SM=[F/(t×1)]/[s/L_{O}]/10⁶

F: Load at 1% elongation of test specimen (unit: N)

t: Thickness of test specimen (unit: m)

l: Width of test specimen (unit: m, 0.02)

L_{O}: Distance between chucks (unit: m, 0.06)

s: 1% Strain (unit: m, 0.0006)

The film according to the present invention has an impact strength of 13 kJ/m² or more. The film has an impact strength of preferably 14 kJ/m² or more, more preferably 15 kJ/m² or more, further preferably 20 kJ/m² or more, further more preferably 23 kJ/m² or more, and most preferably 25 kJ/m² or more. Herein, the impact strength of the film was measured according to A-method described in ASTM D1709.

The film according to the present invention has a tear strength in the MD direction (direction parallel to the draw direction of the film) of 20 kN/m or less. From the viewpoint of ease of cutting the film, the tear strength is preferably 15 kN/m or less, more preferably 12 kN/m or less, further preferably 10 kN/m or less, further more preferably 8 kN/m or less, and most preferably 6 kN/m or less. Herein, the tear strength of the film was measured by the method prescribed in ASTM D1922.

The film according to the present invention has a maximum peak temperature of the melting curve measured by DSC of preferably from 98° C. to 130° C., from the viewpoint of the balance of heat resistance and moldability at which a packaging bag is produced using the film. The maximum peak temperature is preferably 100° C. or more and more preferably 102° C. or more. The maximum peak temperature is preferably 125° C. or less, more preferably 123° C. or less, and further preferably 120° C. or less. Herein, the maximum peak temperature is a melting peak temperature with the largest absolute value of the heat flow that is observed when maintaining 6 to 12 mg of the film packed in an aluminum pan at 150° C. for 5 min, then lowering the temperature to 20° C. at a rate of 5° C/min and maintaining at 20° C. for 2 min, and then raising the temperature to 150° C. at a rate of 5° C/min.

The film according to the present invention is suitable as a packaging bag. The packaging bag can be obtained by heat sealing the film at a prescribed part. At that time, two or more films may be superposed. The heat-sealing method includes a bar sealing method, a roller sealing method, a belt sealing method, an impulse sealing method, a high-frequency sealing method, an ultrasonic sealing method, and the like. As a method for producing a packaging bag with relatively small width, a method of producing a co-extruded blown laminated film with a folded diameter preliminarily matched to a prescribed width, cutting the film into a prescribed length, then heat sealing one end thereof, so-called, a method of producing a tube bag, is desired also in terms of cost.

The film according to the present invention can be used in packaging bags for foods, fibers, pharmaceuticals, fertilizers, sundries, industrial parts and the like, garbage bags, standard bags, and the like.

The film according to the present invention has light reducing properties, and thus is suitable as a packaging bag for packaging a substance that causes deterioration by light. In addition, the film according to the present invention has ease of cutting, and thus is suitable as a packaging bag in which ease of tearing is desired when the content is taken out. The film according to the present invention has a good balance of impact strength, stiffness and ease of cutting, and thus is suitably used as a standing pouch in which high hardness is desired.

In addition, the film according to the present invention may be, in addition to a layer formed of the resin composition containing the component (A), the component (B) and the component (C), a multilayer film having other layers.

Other layers include layers formed of a polyolefin resin such as a polyethylene resin or a polypropylene resin, layers formed of a polyester resin such as a polyethylene terephthalate or polybutylene terephthalate, layers formed of a polyamide resin such as nylon 6 or nylon 66, a layer formed of cellophane, paper, aluminum foil or the like, and the like. The method for producing a multilayer film includes a coextrusion method, a dry lamination method, a wet lamination method, a sand lamination method, a hot melt lamination method, and the like.

In the case of the multilayer film, the layer formed of the resin composition containing the component (A), the component (B) and the component (C) has a thickness of usually 50% or more and preferably 65% or more.

### EXAMPLES

Hereinbelow, the present invention is further described in more detail based on the examples, but the present invention is not limited to these examples. The evaluation of physical properties was performed according to the following methods.

(1) Melt Flow Rate (MFR, unit: g/10 min)

The melt flow rate of each component was measured under conditions of a test load of 21.18 N and a temperature of 190° C., according to the method prescribed in JIS K 7210 (1995).

(2) Density (d, unit: kg/m³)

The density of the component (B) was measured according to JIS K 6760 (1981) using a sheet with a thickness of 1 mm obtained by press molding at 150° C. The measurement was performed without annealing.

(3) Tensile Impact Strength (unit: kJ/m²)

The tensile impact strength of the sheets used in Reference Examples was measured according to ASTM D1822-68. The larger this value, the better the mechanical strength.

### (4) Elmendorf Tear Strength

Ease of cutting of the films of Examples and Comparative Examples were evaluated using the values of Elmendorf tear strength.

The tear strength of the film was measured for the draw direction of the film (machine direction), according to the method prescribed in ASTM D1922.

(5) 1% Secant Modulus (1% SM) (unit: MPa)

Stiffness of the films of Examples and Comparative Examples was evaluated using the values of 1% secant modulus.

A rectangular test specimen of 20 mm in width and 120 mm in length was collected from the film. As test specimens, a test specimen of which longitudinal direction was the draw direction of the film (MD direction) and a test specimen of which longitudinal direction was the direction perpendicular to the MD direction of the film (TD direction) were prepared. A tensile test was performed using these test specimens under conditions of a chuck interval of 60 mm and a tensile rate of 5 mm/min to determine a stress-strain curve. A load at 1% elongation of the test specimens (unit: N) was obtained from the stress-strain curve, and 1% SM was calculated from the following formula and defined as stiffness of the film.

1% SM=[F/(t×1)]/[s/L₀]/10⁶

F: Load at 1% elongation of test specimen (unit: N)

t: Thickness of test specimen (unit: m)

l: Width of test specimen (unit: m, 0.02)

L₀: Distance between chucks (unit: m, 0.06)

s: 1% Strain (unit: m, 0.0006)

(6) Dirt Impact Strength (unit: kJ/m²)

Impact properties of the films of Examples and Comparative Examples were evaluated using the values of dirt impact strength.

The dirt impact strength of the film was measured according to A-method described in ASTM D1709. It is shown that, the higher the value, the higher the strength of the film.

(7) HAZE (unit: %)

Light reducing properties of the samples used in Examples and Comparative Examples were evaluated using the HAZE values.

The HAZE of the film was measured by the method prescribed in ASTM D1003. It is shown that, the higher the numerical value, the better light reducing properties the film has.

(8) η*_{0.1}/η*₁₀₀ of the component (B)

η*_{0.1}/η*₁₀₀ of the component (B) was calculated by the following procedures.

The dynamic complex viscosity at an angular frequency of from 0.1 rad/sec to 100 rad/sec under the following conditions using a strain controlled rotational viscometer (rheometer). Thereafter, the value obtained by dividing the dynamic complex viscosity at an angular frequency of 0.1 rad/sec (η*_{0.1}) by the dynamic complex viscosity at an angular frequency of 100 rad/sec (η*₁₀₀) (η*_{0.1}/η*₁₀₀) was obtained. ARES manufactured by TA Instruments Inc. was used as the strain controlled rotational rheometer.
Temperature: 190° C.
Geometry: Parallel plate
Plate diameter: 25 mm
Plate interval: 1.5 to 2 mm
Strain: 5%
Angular frequency: 0.1 to 100 rad/sec
Measurement atmosphere: Nitrogen
   (9) Activation Energy of Flow of Component (B) (Ea, unit: kJ/mol)

The activation energy of flow Ea of the component (B) refers to an index of moldability calculated from Arrhenius equation with the shift factor (aT) when dynamic viscoelasticity data at each temperature T (K) measured under the following conditions (a) to (d) is shifted based on the temperature-time superposition principle: log(aT)=Ea/R(1/T−1/T0) (wherein R is a gas constant, and T0 is a reference temperature 463K) using a strain controlled rotational viscometer (rheometer). The Ea value on the condition that the correlation coefficient r2, which was obtained from linear approximation in the Arrhenius plot of log(aT)−(1/T) by using Rhios V. 4.4.4 manufactured by Rheometrics, Inc. as calculation software, was 0.99 or higher was applied. The measurement was performed under nitrogen.
Condition (a) Geometry: Parallel plate, Diameter of 25 mm, Plate Interval: 1.5 to 2 mm
Condition (b) Strain: 5%
Condition (c) Shear rate: 0.1 to 100 rad/sec
Condition (d) Temperature: 190, 170, 150, 130° C.
   (10) Melting Point (Maximum peak temperature)

The melting point of the films of Examples and Comparative Examples were measured according to the following method.

The maximum peak temperature (unit: ° C.) and enthalpy of fusion ΔH (unit: J/g) of the film according to the present invention was measured using Diamond DSC, a differential scanning calorimeter manufactured by PerkinElmer Inc. The maximum peak temperature herein is a melting peak temperature that is observed when maintaining 6 to 12 mg of the film packed in an aluminum pan at 20° C. for 1 min, and then raising the temperature to 200° C. at a rate of 5° C/min. When there were a plurality of peaks, the temperature at a melting peak position showing the highest endothermic amount (unit: mW) among the peaks was defined as the maximum peak temperature (unit: ° C.).

Each component used in Examples of the present invention is as the following.

### Component (A): Polylactic Acid

Trade name “TERRAMAC TE-2000C”, MFR (190° C.)=12 g/10 min, manufactured by Unitika, Ltd.

### Component (B): Ethylene-α-Olefin Copolymer

B-1: Trade name “SUMIKATHENE EP GT140” (ethylene-1-butene-1-hexene copolymer, MFR (190° C.)=0.91 g/10 min, density=914 kg/m³, Ea=64 kJ/mol), manufactured by Sumitomo Chemical Co., Ltd.

B-2: Ethylene-based polymer

Trade name “SUMIKATHENE F200” (low density polyethylene, MFR (190° C.)=2.0 g/10 min, density=919 kg/m³, Ea=65 kJ/mol), manufactured by Sumitomo Chemical Co., Ltd.
Component (C): Ethylene-based polymer having epoxy group

C-1: Trade name “Bondfast E” (ethylene-glycidyl methacrylate copolymer, MFR (190° C.)=3 g/10 min, the content of a repeating unit derived from glycidyl methacrylate=12% by weight), manufactured by Sumitomo Chemical Co., Ltd.

C-2: Trade name “Bondfast 20C” (ethylene-glycidyl methacrylate copolymer, MFR (190° C.)=13 g/10 min, the content of a repeating unit derived from glycidyl methacrylate=19% by weight), manufactured by Sumitomo Chemical Co., Ltd.

C-3: Trade name “ACRYFT WK307” (MFR (190° C.)=7 g/10 min, the content of a repeating unit derived from methyl methacrylate=25% by weight), manufactured by Sumitomo Chemical Co., Ltd.

C-4: Trade name “ACRYFT WH206” (MFR (190° C.)=2 g/10 min, the content of a repeating unit derived from methyl methacrylate=20% by weight), manufactured by Sumitomo Chemical Co., Ltd.

C-5: Trade name “Evatate H2020” (MFR (190° C.)=1.5 g/10 min, the content of a repeating unit derived from vinyl acetate 32 15% by weight, ethylene-vinyl acetate copolymer), manufactured by Sumitomo Chemical Co., Ltd.

C-6: Trade name “Evatate KA30” (MFR (190° C.)=7.0 g/10 min, the content of a repeating unit derived from vinyl acetate=28% by weight, ethylene-vinyl acetate copolymer), manufactured by Sumitomo Chemical Co., Ltd.

### Example 1, Example 3, Example 4

A mixture obtained by mixing the component (A), the component (B) and the component (C) in the composition ratio listed in Table 1 at one time was melt-kneaded at 190° C. using an extruder with a screw diameter of 40 mm, to obtain a resin composition.

Subsequently, the resin composition was molded into a film with a thickness of 50 μm using a blown film molding machine (manufactured by Placo. Co., Ltd., single screw extruding machine with full flight screw (diameter of 30 mmφ, L/D=28), and dies (die diameter of 50 mmφ, lip gap of 0.8 mm), double slit air ring), under the process conditions of a temperature of 190° C., an extrusion amount of 5.5 kg/hr, a frost line distance (FLD) of 200 mm, and a blow ratio of 1.8.

The evaluation results of physical properties of these films are shown in Table 1.

### Example 2

A mixture obtained by mixing the component (A), the component (B) and the component (C) in the composition ratio listed in Table 1 at one time was melt-kneaded at 190° C. using an extruder with a screw diameter of 40 mm, to obtain a resin composition.

Subsequently, a film was produced using a flat die film molding machine manufactured by Sumitomo Heavy Industries Modern, Ltd. In a breaker plate (φ51 mm) of an extruder with a diameter of 50 mm and an L/D of 32 (L is a length of a cylinder of the extruder, and D is a diameter of the extruder), a sintered filter (MFF NF06 manufactured by Nippon seisen Co., Ltd., filtration diameter of 10 μm) was set in a configuration sandwiched with 80 mesh wire cloth. The resin composition was melt-kneaded at 220° C., then supplied through the sintered filter into The flat die (600 mm width) whose temperature was adjusted to 220° C., and extruded from this flat die. Thereafter, the extruded composition was cooled and solidified by drawing with a chill roller at 75° C., to obtain a film with a thickness of 50 μm. The evaluation results of physical properties of the resulting film were shown in Table 1.

### Example 5, Example 6

The resin compositions were produced in the same manner as in Example 1. Subsequently, films with a thickness of 50 μm were produced in the same manner as in Example 1 except for using conditions of an extrusion amount of 8.0 kg/hr and a blow ratio of 2.5. The evaluation results of physical properties of the resulting films are shown in Table 1.

### Example 7

A mixture obtained by mixing the component (A), the component (B) and the component (C) in the composition ratio listed in Table 1 at one time was fed to a twin extruder with a screw diameter of 20 mm at a feed rate of 6 kg/hr and melt-kneaded at 190° C., to obtain a resin composition.

Subsequently, a film with a thickness of 50 μm was produced in the same manner as in Example 1. The evaluation results of physical properties of the resulting films are shown in Table 1.

### Example 8

A resin composition was obtained in the same manner as in Example 7, using the component (A), the component (B) and the component (C) in the composition ratio listed in Table 1.

Subsequently, a film with a thickness of 50 μm was produced in the same manner as in Example 5. The evaluation results of physical properties of the resulting film are shown in Table 2.

### Example 9

A mixture obtained by mixing the component (A), the component (B) and the component (C) in the composition ratio listed in Table 1 at one time was fed to a twin extruder with a screw diameter of 20 mm at a feed rate of 4 kg/hr and melt-kneaded at 190° C., to obtain a resin composition.

Subsequently, a film with a thickness of 50 μm was produced in the same manner as in Example 1. The evaluation results of physical properties of the resulting film are shown in Table 2.

### Example 10

A mixture obtained by mixing at a rate of 60% by weight of the component (A), 30% by weight of the component (B-1) and 10% by weight of the component (C-1) at one time was fed to a twin extruder with a screw diameter of 20 mm at a feed rate of 6 kg/hr and melt-kneaded at 190° C., to obtain a resin composition (MB-1).

A mixture obtained by mixing at a rate of 50% by weight of the resulting resin composition (MB-1) and 50% by weight of the component (B-1) at one time was fed to a twin extruder with a screw diameter of 20 mm at a feed rate of 6 kg/hr and melt-kneaded at 190° C., to obtain a resin composition (CO-1).

Subsequently, a film with a thickness of 50 μm was produced in the same manner as in Example 1.

Final composition of the component (A), the component (B) and the component (C) contained in the resin composition (CO-1) and the evaluation results of physical properties of the resulting film are shown in Table 2.

### Example 11

The resin composition (CO-1) was obtained in the same manner as in Example 10.

Subsequently, a film with a thickness of 50 μm was produced in the same manner as in Example 1 except for using conditions of an extrusion amount of 8.0 kg/hr and a blow ratio of 2.5. Final composition of the component (A), the component (B) and the component (C) contained in the resin composition (CO-1) and the evaluation results of physical properties of the resulting film are shown in Table 2.

### Example 12

A mixture obtained by mixing at a rate of 60% by weight of the component (A), 30% by weight of the component (B-1) and 10% by weight of the component (C-1) at one time was fed to a twin extruder with a screw diameter of 20 mm at a feed rate of 4 kg/hr and melt-kneaded at 190° C., to obtain a resin composition (MB-2).

A mixture obtained by mixing at a rate of 50% by weight of the resulting resin composition (MB-2) and 50% by weight of the component (B-1) at one time was fed to a twin extruder with a screw diameter of 20 mm at a feed rate of 4 kg/hr and melt-kneaded at 190° C., to obtain a resin composition (CO-3).

Subsequently, a film with a thickness of 50 μm was produced in the same manner as in Example 1. Final composition of the component (A), the component (B) and the component (C) contained in the resin composition (CO-3) and the evaluation results of physical properties of the resulting film are shown in Table 2.

### Example 13

A mixture obtained by mixing the component (A), the component (B) and the component (C) in the composition ratio listed in Table 1 at one time was melt-kneaded at 190° C. using an extruder with a screw diameter of 40 mm, to obtain a resin composition.

Subsequently, a film with a thickness of 50 μm was produced in the same manner as in Example 1 except for using conditions of an extrusion amount of 8.0 kg/hr, a frost line distance (FLD) of 150 mm, and a blow ratio of 2.5. The evaluation results of physical properties of the resulting film are shown in Table 2.

### Comparative Examples 1 to 10

A mixture obtained by mixing the component (A), the component (B) and the component (C) in the composition ratio listed in Table 2 at one time was melt-kneaded at 190° C. using an extruder with a screw diameter of 40 mm, to obtain a resin composition. Subsequently, the resin composition was molded into a film with a thickness of 50 using a blown film molding machine (manufactured by Placo. Co., Ltd., single screw extruding machine with full flight screw (diameter of 30 mmφ, L/D=28), and dies (die diameter of 50 mmφ, lip gap of 0.8 mm), double slit air ring), under the process conditions of a temperature of 190° C., an extrusion amount of 5.5 kg/hr, a frost line distance (FLD) of 200 mm, and a blow ratio of 1.8. The evaluation results of physical properties of the films obtained in Comparative Examples 1 to 10 are shown in Table 3 and Table 4.

### Reference Examples 1 to 5

A mixture obtained by mixing the component (A), the component (B) and the component (C) in the composition ratio listed in Table 2 at one time was melt-kneaded at 190° C. using an extruder with a screw diameter of 40 mm, to obtain a resin composition. This resin composition was pressed under conditions of a temperature of 190° C., a preheating time of 10 min, a compression time of 5 min and a compression pressure of 5 MPa, to obtain a sheet with a thickness of 2 mm. The tensile impact strength of the sheets was measured according to ASTM D1822-68. The tensile impact strength of the resulting sheets was listed in Table 5 as reference examples. In addition, MFR, density, activation energy of flow and η*_{0.1}/η*₁₀₀ of the component (B) (B-1 and B-2) were listed in Table 2.

When Reference Example 1 and Reference Example 2 in Table 5 are compared, Reference Example 2 has higher tensile impact strength. On the other hand, when Comparative Example 1 having a composition corresponding to Reference Example 2 is compared with Example 1 corresponding to Reference Example 1, it is found that Example 1 has higher impact strength of the film. The present invention is to find that a resin composition is processed into a film, thereby expressing strength.

TABLE 1

| Physical Properties | | Example 1 | Example 2 | Example 3 | Example 4 | Example 5 | Example 6 | Example 7 |
|---|---|---|---|---|---|---|---|---|
| Resin Composition | | | | | | | | |
| (% by weight) | | | | | | | | |
| Component (A) | | 30 | 30 | 25 | 30 | 30 | 30 | 30 |
| Component | B-1 | 65 | 65 | 70 | 65 | 65 | 65 | 65 |
| (B) | B-2 | | | | | | | |
| Component | C-1 | 5 | 5 | 5 | | | 5 | 5 |
| (C) | C-2 | | | | 5 | 5 | | |

| | | | | | | | |
|---|---|---|---|---|---|---|---|
| Physical | | | | | | | |
| Properties | | | | | | | |
| MD Tear | 3.9 | 2.0 | 11 | 3.9 | 2.9 | 3.9 | 2.9 |
| Strength | | | | | | | |
| [kN/m] | | | | | | | |
| 1% Secant | 667 | 657 | 501 | 522 | 511 | 640 | 665 |
| Modulus [MPa] | | | | | | | |
| Impact | 28.2 | 15.4 | 29.3 | 24.7 | 30.3 | 29.4 | 30.8 |
| Strength | | | | | | | |
| [kJ/m²] | | | | | | | |
| HAZE [%] | 45.9 | 50.2 | 39.1 | 77.8 | 80.5 | 54.7 | 42.6 |
| Melting Point | 103 | 102 | 103 | 103 | 103 | 103 | 103 |
| [° C.] | | | | | | | |

TABLE 2

| | | Ex- | Ex- | Ex- | Ex- | Ex- | Ex- |
|---|---|---|---|---|---|---|---|
| Physical | | am- | am- | ample | ample | ample | ample |
| Properties | | ple 8 | ple 9 | 10 | 11 | 12 | 13 |
| Resin | | | | | | | |
| Composition | | | | | | | |
| (% by weight) | | | | | | | |
| Component (A) | | 30 | 30 | 30 | 30 | 30 | 30 |
| Component | B-1 | 65 | 65 | 65 | 65 | 65 | 65 |
| (B) | B-2 | | | | | | |
| Component | C-1 | 5 | 5 | 5 | 5 | 5 | 5 |
| (C) | C-2 | | | | | | |

| | | | | | | |
|---|---|---|---|---|---|---|
| Physical | | | | | | |
| Properties | | | | | | |
| MD Tear | 3.9 | 3.9 | 2.9 | 2.9 | 3.9 | 4.9 |
| Strength [kN/m] | | | | | | |
| 1% Secant | 640 | 666 | 658 | 646 | 686 | 612 |
| Modulus [MPa] | | | | | | |
| Impact Strength | 28.2 | 31.3 | 29.2 | 31.3 | 30.3 | 32.1 |
| [kJ/m²] | | | | | | |
| HAZE [%] | 44.9 | 42.2 | 43.2 | 45.2 | 44.9 | 53.9 |
| Melting Point | 103 | 103 | 103 | 103 | 103 | 103 |
| [° C.] | | | | | | |

TABLE 3

| Physical | | Comparative | Comparative | Comparative | Comparative | Comparative | Comparative |
|---|---|---|---|---|---|---|---|
| Properties | | Example 1 | Example 2 | Example 3 | Example 4 | Example 5 | Example 6 |
| Resin Composition | | | | | | | |
| (% by weight) | | | | | | | |
| Component (A) | | | 30 | 15 | | 30 | 30 |
| Component | B-1 | 100 | 70 | 85 | | | |
| (B) | B-2 | | | | 100 | 65 | 70 |
| Component | C-1 | | | | | 5 | |
| (C) | C-2 | | | | | | |
| | C-3 | | | | | | |
| | C-4 | | | | | | |
| | C-5 | | | | | | |
| | C-6 | | | | | | |

| | | | | | | |
|---|---|---|---|---|---|---|
| Physical | | | | | | |
| Properties | | | | | | |
| MD Tear Strength | 22.6 | 2.0 | 22.6 | 66 | 3.0 | 2.0 |
| [kN/m] | | | | | | |
| 1% Secant | 115 | 608 | 383 | 162 | 628 | 515 |
| Modulus [MPa] | | | | | | |
| Impact Strength | 27.1 | 0.0 | 20.4 | 20.9 | 12.5 | 0.0 |
| [kJ/m²] | | | | | | |
| HAZE [%] | 4.3 | 63 | 59.7 | 5 | 46.1 | 64.3 |
| Melting Point | 104 | 103 | 103 | 107 | 106 | 107 |
| [° C.] | | | | | | |

TABLE 4

| | | Compara- | Compara- | Compara- | Compara- |
|---|---|---|---|---|---|
| Physical | | tive | tive | tive | tive |
| Properties | | Example 7 | Example 8 | Example 9 | Example 10 |
| Resin | | | | | |
| Composition | | | | | |
| (% by weight) | | | | | |
| Component (A) | | 30 | 30 | 30 | 30 |
| Component | B-1 | 65 | 65 | 65 | 65 |
| (B) | B-2 | | | | |
| Component | C-1 | | | | |
| (C) | C-2 | | | | |
| | C-3 | 5 | | | |
| | C-4 | | 5 | | |
| | C-5 | | | 5 | |
| | C-6 | | | | 5 |

| | | | | |
|---|---|---|---|---|
| MD Tear Strength | 2.9 | 2.9 | 2.9 | 2.9 |
| [kN/m] | | | | |
| 1% Secant Modulus | 642 | 619 | 617 | 637 |
| [MPa] | | | | |
| Impact Strength | 0.0 | 0.0 | 0.0 | 0.0 |
| [kJ/m²] | | | | |
| HAZE [%] | 66 | 66.8 | 66.7 | 65.5 |
| Melting Point [° C.] | 103 | 103 | 103 | 103 |

TABLE 5

| Physical | | Reference | Reference | Reference | Reference | Reference | Reference |
|---|---|---|---|---|---|---|---|
| Properties | | Example 1 | Example 2 | Example 3 | Example 4 | Example 5 | Example 6 |
| Resin Composition | | | | | | | |
| (% by weight) | | | | | | | |
| Component (A) | | 30 | 0 | 15 | 30 | 15 | 0 |
| Component | B-1 | 65 | 100 | 80 | 70 | 85 | |
| (B) | B-2 | | | | | | 100 |
| Component | | 5 | 0 | 5 | 0 | 0 | 0 |
| (C) | | | | | | | |

| | | | | | | |
|---|---|---|---|---|---|---|
| Physical | | | | | | |
| Properties | | | | | | |
| Tensile Impact | 123 | 637 | 292 | 29 | 518 | 190 |
| Strength [kJ/m²] | | | | | | |
| MFR | — | 0.91 | — | — | — | 2.0 |
| [g/10 min] | | | | | | |
| Density | — | 914 | — | — | — | 919 |
| [kg/m³] | | | | | | |
| Ea | — | 64 | — | — | — | 65 |
| [kJ/mol] | | | | | | |
| η*_{0.1}/η*₁₀₀ | — | 33 | — | — | — | 13 |

### INDUSTRIAL APPLICABILITY

According to the present invention, a polyethylene-based resin film having a good balance of impact strength, stiffness and light reducing properties and having ease of cutting can be provided.

1. A polyethylene-based resin film,
wherein the film is formed of a resin composition comprising the following component (A), component (B) and component (C), and
when the total amount of the component (A), the component (B) and the component (C) contained in the resin composition is 100% by weight, the content of the component (A) is from 18 to 40% by weight, the content of the component (B) is from 55 to 77% by weight, and the content of the component (C) is from 3 to 15% by weight:
component (A): an aliphatic polyester,
component (B): an ethylene-α-olefin copolymer having an activation energy of flow (Ea) of from 45 to 100 kJ/mol,
component (C): a compatibilizer for the component (A) and the component (B).

2. The film according to claim 1, wherein the component (A) is a polylactic acid, a poly-3-hydroxybutylic acid ester, or their mixture.

3. The film according to claim 1, wherein the ethylene-α-olefin copolymer has a density of from 905 to 950 kg/m³ and a melt flow rate of from 0.1 to 10 g/10 min.

4. The film according to claim 1, wherein the film has a thickness from 5 to 300 μm.

5. A polyethylene-based resin film having a HAZE of from 20 to 90%, a 1% secant modulus of from 500 to 1200 MPa, an impact strength of 13 kJ/m² or more, and a tear strength of 20 kN/m or less.

6. The film according to claim 2, wherein the ethylene-α-olefin copolymer has a density of from 905 to 950 kg/m³ and a melt flow rate of from 0.1 to 10 g/10 min.

7. The film according to claim 2, wherein the film has a thickness of 5 to 300 μm.

8. The film according to claim 3, wherein the film has a thickness of 5 to 300 μm.
